(19) United States
(12) Patent Application Publication
(10) Pub. No.: US 2006/0167573 A1
(43) Pub. Date: Jul. 27, 2006

(54) Control panel apparatus

(75) Inventor: Masayuki Yamada, Osaka-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: KYOCERA MITA CORPORATION, Osaka-shi (JP)

(21) Appl. No.: 11/333,586

(22) Filed: Jan. 17, 2006

(30) Foreign Application Priority Data
Jan. 21, 2005 (JP) JP 2005-014280

(51) Int. Cl. G05B 11/01; G05B 15/00

(52) U.S. Cl. 700/83; 700/17

(57) ABSTRACT

To improving controllability while avoiding an operation error regardless of the individual user. A control panel apparatus having a display section 2 capable of displaying a control screen 3. The display section is capable of color display of a plurality of control menu screens 17-20 provided respectively for a plurality of control menus with background colors different from each other.

### BACKGROUND OF THE INVENTION

1. Field of the Invention

The present invention relates to a control panel apparatus having a display section capable of displaying a control screen.

2. Related Art

With the control panel apparatus described above, there is provided a display section capable of displaying, when needed, a control screen corresponding to a desired control purpose, thus allowing user's various operations. At the same time, this construction provides advantageous possibility of reduced numbers and/or simplified layouts of control buttons, switches, etc. Conventionally, for achieving improvement of operability of the apparatus, there has been proposed a control panel apparatus capable of displaying the control screens with a color coordination pattern suiting each user's preference (see e.g. Patent Document 1 identified below).

Patent Document 1: Japanese Patent Application “Kokai” No. 2004-200955

Taking note of the fact that the readiness of visual recognition differs depending on each individual user's use condition and/or each user's preference, for the purpose of improvement of controllability of each individual user, the conventional control panel apparatus described above is configured to be capable of displaying the control screen with a certain particular color coordination pattern for each individual user, so as to avoid an operation error, irrespectively of the individual user. However, this apparatus does not contemplate any improvement of controllability of the apparatus.

The present invention has been made in view of the above-described state of the art. A primary object of the invention is improving the controllability of the apparatus in addition to the possibility of avoiding an operation error regardless of the individual user.

### SUMMARY OF THE INVENTION

For accomplishing the above-noted object, according to the first characterizing feature of the invention, there is proposed a control panel apparatus having a display section capable of displaying a control screen;

wherein said display section is capable of color display of said control screen in the form of a plurality of control menu screens provided respectively for a plurality of control menus with background colors different from each other.

With the above-described construction, the display section is capable of color display of the control screen in the form of a plurality of control menu screens provided respectively for a plurality of control menus with background colors different from each other. Hence, by viewing the background color of the control menu screen which is being color-displayed on the displaying unit, the user can immediately (intuitively) recognize the control menu corresponding to that control menu screen. As a result, it has become possible to improve the controllability while avoiding an operation error in selecting the control menu, regardless of the user.

According to the second characterizing feature of the present invention, each of said plural control menu screens includes a menu selecting tag displaying area which is displayed with said respective background color; and

said display section is capable of displaying said plural control menu screens in such a manner that at least tag displaying areas thereof are displayed simultaneously.

With the above-described construction, each of the plural control menu screens includes its own menu selecting tag displaying area which is displayed with said respective background color assigned thereto. And, the display section is capable of displaying said plural control menu screens in such a manner that at least tag displaying areas thereof are displayed simultaneously. Hence, by viewing the respective colors of the plurality of tag displaying areas being simultaneously displayed on the display section, the user can immediately recognize the control menu of the control menu screen corresponding to each tag displaying area. Therefore, it is possible to prevent any user from making an operation error in selecting a desired control menu by its tag displaying area, thus improving the operability of the apparatus.

According to the third characterizing feature of the present invention, there is proposed a control panel apparatus having a display section capable of displaying a control screen, the apparatus comprising:

a selecting operation section for allowing selection between a color image forming mode and a monochrome image forming mode of an image forming machine;

wherein said display section is capable of displaying a control screen which displays, in colors, a selected condition of the color image forming mode when this color image forming mode is selected and displays, in monochrome, a selected condition of the monochrome display mode when this monochrome image forming mode is selected.

With the above-described construction, the control panel apparatus having a display section capable of displaying a control screen includes a selecting operation section for allowing selection between a color image forming mode and a monochrome image forming mode of an image forming machine. And, the display section is capable of displaying a control screen which displays, in colors, a selected condition of the color image forming mode when this color image forming mode is selected and displays, in monochrome, a selected condition of the monochrome display mode when this monochrome image forming mode is selected. Hence, if the user finds the control screen displaying a selected condition is being displayed in colors in the display section, the user can immediately and readily recognize that the color image forming mode has been selected. Whereas, if the control screen is displayed in monochrome, the user can immediately and readily recognize that the monochrome image forming mode has been selected. Therefore, it is possible to avoid the operation error in selecting either the color image forming mode or the monochrome image forming mode, regardless of the user, thus improving the operability of the apparatus.

According to the fourth characterizing feature of the present invention, there is proposed a control panel apparatus having a display section capable of displaying a control screen, the apparatus comprising:

a density setting section for allowing variable setting of a printing density of an image to be formed by an image forming machine;

wherein said display section is capable of displaying a control screen including a preview image of the formed image reflecting a printing density set by said density setting section.

With the above-described construction, the control panel apparatus having a display section capable of displaying a control screen includes a density setting section for allowing variable setting of a printing density of an image to be formed by an image forming machine. And, the display section is capable of displaying a control screen including a preview image of the formed image image to be formed) reflecting a printing density set by said density setting section. Hence, by viewing the preview image in the control screen being displayed in the display section, the user can determine in advance with high precision whether the actual (set) printing density is appropriate or not. Therefore, it is possible to avoid the operation error in printing an formed image, regardless of the user, thus improving the operability of the apparatus.

According to the fifth characterizing feature of the present invention, there is proposed a control panel apparatus having a display section capable of displaying a control screen, the apparatus comprising:

a displaying magnification varying section capable of varying operation of a displaying magnification of the control screen being displayed on the display section.

With the above-described construction, control panel apparatus having a display section capable of displaying a control screen includes a displaying magnification varying section capable of variable setting of a displaying magnification of the control screen being displayed on the display section. Hence, the user can see the control screen in a certain displaying magnification suitable for his/her eyesight Therefore, it is possible to avoid the operation error on the control screen, regardless of the user, thus improving the operability of the apparatus.

Further and other features and advantages of the present invention will become apparent upon reading the following detailed description of the preferred embodiments thereof with reference to the accompanying drawings.

### BRIEF DESCRIPTION OF THE DRAWINGS

FIG. 1 is a block diagram for illustrating a control panel apparatus,

FIG. 2 is an explanatory view of a display section (control screen),

FIG. 3 is an explanatory view showing a displayed condition of a preview image,

FIG. 4 is an explanatory view of a displayed condition of an enlarged display screen.

### DESCRIPTION OF PREFERRED EMBODIMENTS

Next, a preferred embodiment of the present invention will be described with reference to the accompanying drawings.

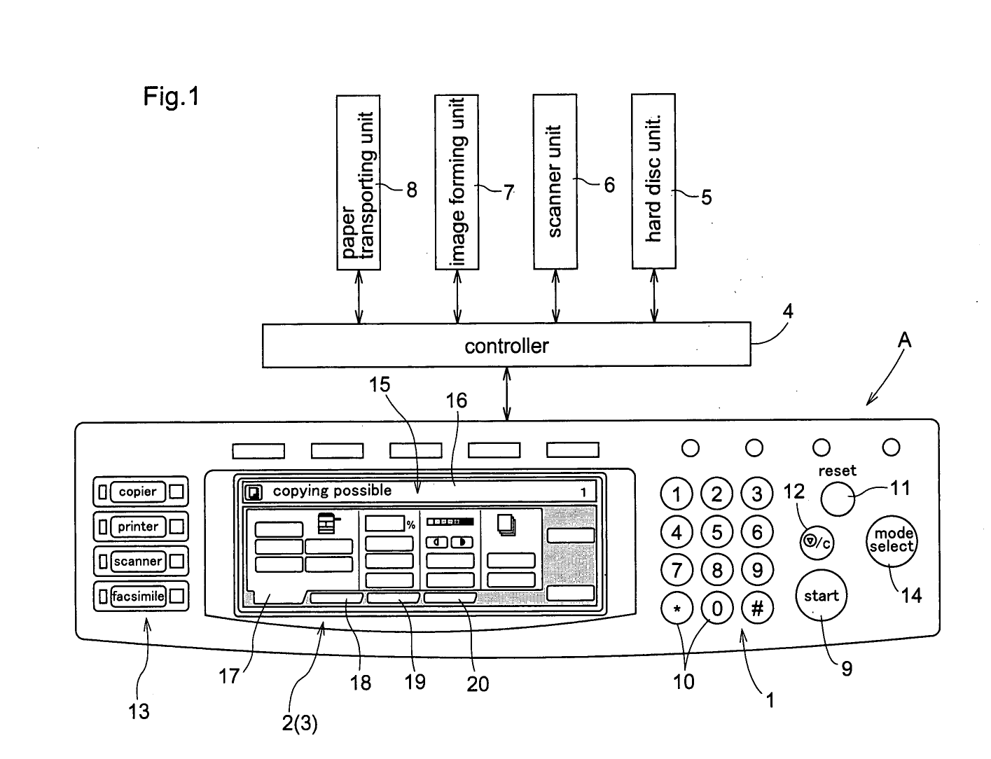

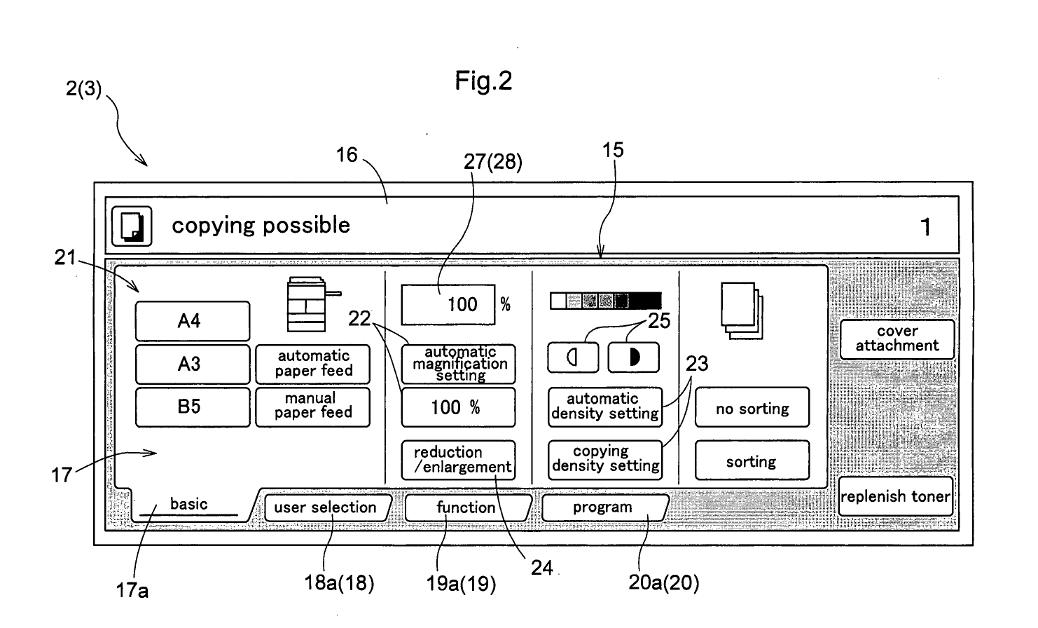

FIGS. 1 and 2 show a control panel apparatus A relating to the present invention included in a “hybrid” (multi-purpose) image forming machine (an example of “image forming machine”) having a copier function, a printer function, a scanner function and a facsimile function altogether. The control panel apparatus A includes a control section 1 for allowing control inputs for causing the image forming machine to effect various image processing operations and a crystal liquid display section 2 capable of polychromatic display of control screens 3.

And, for executing a control program corresponding to a setting input set by the control panel apparatus A, there is provided a controller 4 for controlling operations of a hard disc unit 5, a scanner unit 6, an image forming unit 7, a paper transporting unit 8, etc. corresponding to each particular function selected and controlling also the displaying operation by the liquid crystal displaying section 2. The controller 4 allows also execution of a control program for causing the scanner unit 6 to scan an image in an original document placed on a document mounting table (not shown) and causing the scanned image data to be stored at the hard disc unit 5.

The control section 1 includes a start key 9 for inputting an instruction for execution of printing, a set of ten keys 10 for inputting e.g. the number of print(s) to be made, a reset key 11 for resetting contents set by the control section 1, a stop key 12 for stopping an image forming operation being executed, a group of function selecting keys 13 for selecting a desired function from among the copier function, the printer function, the scanner function and the facsimile function, an image mode selecting key 14 (an example of “selecting operation section”) for selecting a color image forming mode and a monochrome image forming mode, and so on.

The liquid crystal display section 2 has a touch-panel function as a controlling means capable of controlling a control screen 3 being displayed. During e.g. its standby condition when no image processing operation is being effected, the machine is switched to e.g. the copier function to display an initial screen 15, as shown in FIG. 2, the display section 2 is capable of color displaying, as copier control screens 3, a function display screen 16 indicating a copying function being made possible, and a plurality of control menu screens 17, 18, 19, 20 provided respectively for a plurality of control menus with background colors differing from each other.

Each of the control menu screens 17-20 includes tag displaying areas 17a, 18a, 19a, 20a for menu selection which are displayed with corresponding background colors. In displaying the plurality of control menu screens 17, 18, 19, 20 for the plural control menus, the liquid crystal display section 2 is constructed such that at least the tag displaying areas 17a through 20a thereof are color-displayed simultaneously.

More particularly, the basic control menu screen 17 has a yellow background color and corresponds to the basic control menu. The user selection control menu screen 18 has a green background color and corresponds to a user selection control menu. The function selection control menu screen 19 has a blue background color and corresponds to an image processing function selection control mode. The program selection control menu 20 has a red background color and corresponds to an image processing operation execution program selection control menu. Then, in the exemplary case illustrated in FIG. 2, the entire basic control menu screen 17 is being displayed together with its own tag displaying area 17a, and at the same time, the respective tag displaying areas 18a through 20a of the user selection control menu screen 18, the function selection control menu screen 19 and the program selection control menu 20 are being displayed also on the liquid crystal display section 2.

The basic control menu screen 17 includes a paper size setting section 21 for setting a paper size, a magnification setting section 22 for setting a copy magnification, a density setting section 23 for setting a printing density, and so on. With a touch operation on an enlarging/reducing key 24 of the magnification setting section 22, a desired copy magnification can be set. Further, with a touch operation on a density setting key 25 of the density setting section 23, a desired printing density can be set.

The controller 4 controls the display operation of the liquid crystal display section 2 in such a manner that when the color image forming mode is selected, this selection condition is displayed by color display of the function display screen 16, whereas when the monochrome image forming mode is selected, this selection condition is displayed by monochrome display of the function display screen 16 and also that one of the control menu screens 17-20 corresponding to a touched one of the tag displaying areas 17a-20a is displayed in its entirety.

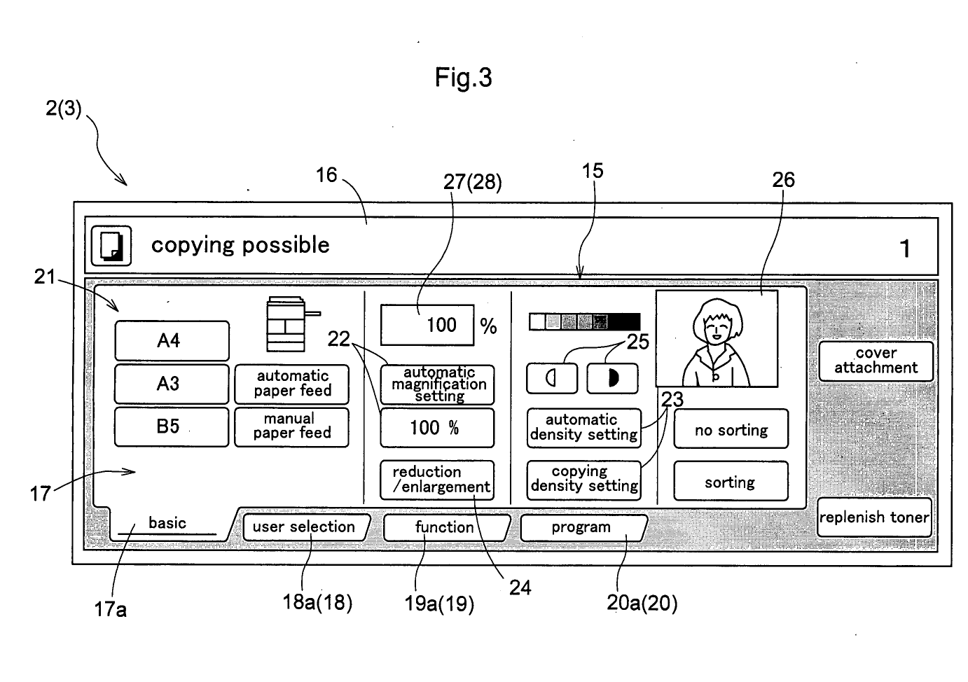

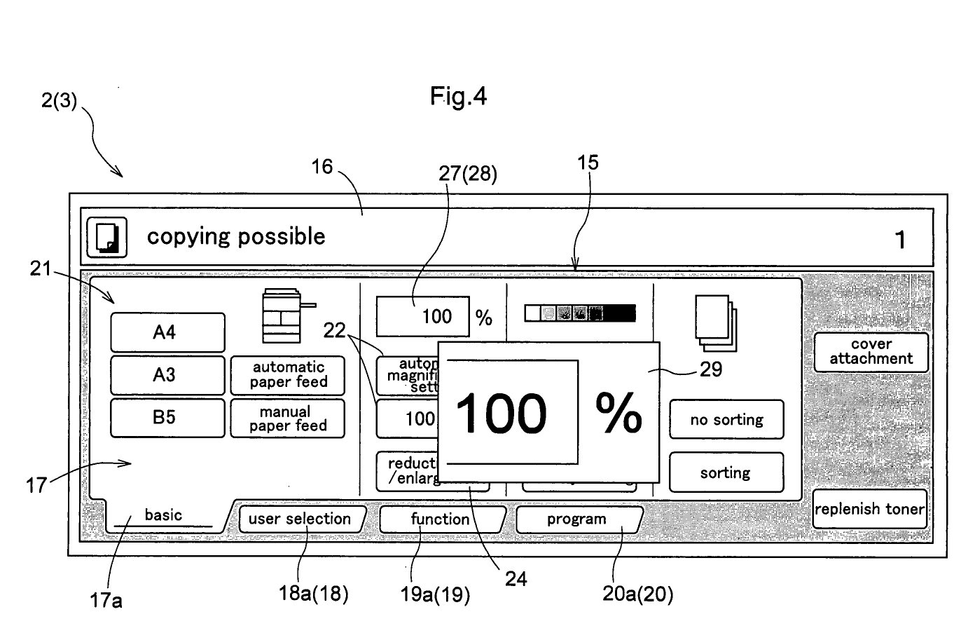

Further, if a printing density is set by the density setting key 25 while the image data of a document placed on the document mounting table are stored at the hard disc unit 5, the controller 4 controls the display operation of the liquid crystal display section 2 to display a preview image 26 of an image to be formed (image to be printed) reflecting this set printing density, as shown in FIG. 3. Further, a magnification setting section 27 capable of variably setting a displaying magnification of the control screen 30 which is being displayed on the liquid crystal display section 2 is provided in the form of a set magnification displaying section 28. And, the controller 4 controls the liquid crystal display section 2 such that with a touch operation on the set magnification displaying section 28, the displaying area is enlarged to show an enlarged set magnification displaying screen 29 as shown in FIG. 4.

### Other Embodiments

1. The control panel apparatus of the invention can include a controlling means adapted for controlling the control screen in association with a movement of a cursor shown in the control screen by means of a mouse or a controlling means adapted for controlling the control screen in association with an operation on a control button provided in the control section.

2. In the control panel apparatus of the invention, the display section can be alternatively constructed such that the plurality of control menu screens provided for the respective control menus are shown in their entireties at one time with the mutually differing background colors.

3. In the control panel apparatus of the invention, a selecting operation section for allowing selection between the color image forming mode and the monochrome image forming mode can be provided in the control screen being displayed on the display section.

4. In the control panel apparatus of the invention, the density setting section may be provided in a control section other than the display section for the control screen.

5. In the control panel apparatus of the invention, the displaying magnification varying section capable of varying the displaying magnification of the control screen which is being displayed in the display section may be provided in a control section other than the display section for the control screen.

6. The control panel apparatus of the invention may be included in an image forming machine having only one of the copier function, the printer function, the scanner function, and the facsimile function.

7. The control panel apparatus of the invention may be included in various types of machines or apparatuses other then the image forming machine, such as a microwave oven, a refrigerator, a washing machine, etc.

What is claimed is:

1. A control panel apparatus having a display section capable of displaying a control screen;
wherein said display section is capable of color display of said control screen in the form of a plurality of control menu screens provided respectively for a plurality of control menus with background colors different from each other.

2. The control panel apparatus according to claim 1, wherein each of said plural control menu screens includes a menu selecting tag displaying area which is displayed with said respective background color; and
said display section is capable of displaying said plural control menu screens in such a manner that at least tag displaying areas thereof are displayed simultaneously.

3. A control panel apparatus having a display section capable of displaying a control screen, the apparatus comprising:
a selecting operation section for allowing selection between a color image forming mode and a monochrome image forming mode of an image forming machine;
wherein said display section is capable of displaying a control screen which displays, in colors, a selected condition of the color image forming mode when this color image forming mode is selected and displays, in monochrome, a selected condition of the monochrome display mode when this monochrome image forming mode is selected.

4. A control panel apparatus having a display section capable of displaying a control screen, the apparatus comprising:
a density setting section for allowing variable setting of a printing density of an image to be formed by an image forming machine;
wherein said display section is capable of displaying a control screen including a preview image of the formed image reflecting a printing density set by said density setting section.

5. A control panel apparatus having a display section capable of displaying a control screen, the apparatus comprising:
a displaying magnification varying section capable of varying operation of a displaying magnification of the control screen being displayed on the display section.
